(19) United States
(12) Patent Application Publication
(10) Pub. No.: US 2025/0246942 A1
(43) Pub. Date: Jul. 31, 2025

(54) WIRELESS CHARGER

(71) Applicant: Yitao XING, Shenzhen (CN)

(72) Inventor: Yitao XING, Shenzhen (CN)

(21) Appl. No.: 19/183,743

(22) Filed: Apr. 18, 2025

Related U.S. Application Data
(63) Continuation of application No. PCT/CN2023/112099, filed on Aug. 10, 2023.

(30) Foreign Application Priority Data
Oct. 20, 2022 (CN) 202211284238.2

(51) Int. Cl. H02J 50/70; H01F 27/33; H02J 50/10

(52) U.S. Cl. CPC H02J 50/70; H02J 50/10; H01F 27/33

(57) ABSTRACT

A wireless charger, which is characterized in having a coil module and a power supply module. The power supply module is provided with an alternating-current power generation submodule and a transformer. The alternating-current submodule is electrically connected to a primary side TF1 of the transformer by means of a first high-frequency low-resistance circuit, and a secondary side TF2 of the transformer is electrically connected to an alternating-current energy input lead of the coil module by means of a second high-frequency low-resistance circuit.

### RELATED APPLICATIONS

This application is a continuation application of PCT application No. PCT/CN2023/112099, filed on Aug. 10, 2023, and the content of which is incorporated herein by reference in its entirety.

The present application claims the benefit of priority of Chinese Patent Application No. 202211284238.2, filed Oct. 20, 2022, and entitled “WIRELESS CHARGER,” the entire content of which is incorporated herein by reference.

### TECHNICAL FIELD

The present invention relates to a circuit topology of a wireless charger, particularly to achieving a circuit topology that conforms to extremely low electromagnetic noise characteristics.

### BACKGROUND

The current commercially sold wireless chargers often generate electromagnetic noise that cannot be lower than 5 dB below the international electromagnetic compatibility certification standard (such as EN55022B) qualified line without adding dedicated and expensive filtering and electromagnetic noise reduction circuits. Therefore, they are not suitable for use in situations where electromagnetic noise is highly sensitive.

This situation is particularly prone to occur in wireless chargers where the alternating current generating module and coil module are separated in space and electrically connected through transmission cables. For example, the electromagnetic noise of CN201410004299.8 applied by the inventor in 2014 often exceeds the qualified line of EN55022B and has strong electromagnetic noise.

Therefore, the inventor applied for CN201920087512.4 (as well as the patent CN201910050564.9 of the same family that is still under examination) in 2019. Although it achieved electromagnetic noise lower than the qualified line of EN55022B, it is also difficult to achieve a noise level lower than the qualified line by more than 5 dB.

### SUMMARY

According to the research of the present inventor for many years, the physical cause of the electromagnetic noise caused by the separation wireless charger SWPT is that when the power supply module generates alternating current, it often produces square wave voltage alternating electrical power or stepped voltage alternating electrical power, which is with the current and voltage information of a wide frequency band, are then coupled to the transmission cable and coil module by direct electrical connection or matched resonant capacitors, resulting in obvious wide-frequency band common-mode oscillation of the transmission cable and coil module.

Therefore, the CN201920087512.4 patented technology adds a stable potential eddy current damper to the coil module, and adds a conductor that electrically connects the stable potential eddy current damper with the stable voltage level on the power supply module in the transmission cable, and realizes the effect of suppressing the wide-frequency domain common-mode oscillation by bringing the transmission cable and the coil module close to the stable voltage level. As a result, electromagnetic noise is reduced and electromagnetic noise is reduced. However, compared with the CN201410004299.8 patented technology, the CN201920087512.4 patented technology not only increases the structural complexity and production process, but also has a poor electromagnetic noise suppression effect, and the electromagnetic noise in the frequency band of 10˜100 MHz is still relatively close to the upper limit threshold of the certification standard, and it is difficult to achieve extremely low electromagnetic noise in the full frequency domain, therefore high-cost active filtering circuits may be required for use in certain applications where EMC (ElectroMagnetic Compatibility) requirements are very strict and wireless charging is necessary, such as hospital testing rooms. Moreover, the stable potential eddy current damper added by the CN201920087512. 4 patented technology is often a continuous sheet conductor, when the continuous conductor is close to the coil module in operation, eddy currents will be generated because of the alternating magnetic field leaked out of the coil module, and then heat will be generated, when the working power of the coil module exceeds 100 W, the heat on the stabilising potential eddy current damper may exceed 5 W and may produce a temperature rise of 50° C., which is unsafe.

Therefore, it is necessary to design a wireless charger circuit topology with simple structure, few production processes, extremely low temperature rise of the coil module during charging, and extremely low electromagnetic noise in the full frequency band.

The present invention reveals a wireless charger characterized by a coil module and a power supply module; the coil module has a coil converting alternating current energy into an alternating magnetic field, and the coil has at least one pair of alternating energy input leads; the power supply module has an alternating current generating submodule and a transformer, the alternating current electronic module is electrically connected with the primary side TF1 of the transformer through a first high-frequency low-resistance circuit, and the secondary side TF2 of the transformer is electrically connected with the alternating current energy input leads of the coil module through the second high-frequency low-resistance circuit.

The basic principle of the present invention is to use the primary side TF1 and the secondary side TF2 of the transformer to transmit alternating current energy, and the capacitance between the primary side TF1 and the secondary side TF2 of the transformer is extremely small, making it difficult to perform electric field coupling and not directly electrically connected, thereby greatly reducing or even eliminating the electric field coupling between the alternating current generating submodule and the transmission cable and coil module, and thus greatly reducing or even eliminating the wide band common mode oscillation generated on the transmission cable and coil module, thus achieving a wireless charger with extremely low electromagnetic noise characteristics.

Furthermore, in order to avoid magnetic saturation during transformer operation, the second high-frequency low-resistance circuit is with a second capacitor group Cg2. The first end of the second capacitor group Cg2 is electrically connected to the secondary side TF2 of the transformer, and the second end of the second capacitor group Cg2 is electrically connected to the corresponding lead of the coil. Furthermore, the first high-frequency low-resistance circuit is a with first capacitor group Cg1, whose first end is electrically connected to the output terminal of the alternating current generating submodule, and whose second end is electrically connected to the primary side TF1 of the transformer.

According to the test results, when the capacitance Ct formed by the winding Q1 on the primary side of the transformer and the winding Q2 on the secondary side of the transformer is less than 100 pF, the wide band common mode oscillation caused by the power supply module on the transmission cable and coil module will be significantly reduced. Moreover, the smaller the capacitance Ct, the lower the amplitude of the wide band common mode oscillation and the narrower the frequency domain of the common mode oscillation effect. Therefore, there is a gap between the conductor T1 of the primary side winding of the transformer and the conductor T2 of the secondary side winding of the transformer, and the capacitance formed between the conductor T1 of the primary side winding of the transformer and the conductor T2 of the secondary side winding of the transformer is less than 100 pF.

To minimize the capacitance value of capacitor Ct, the transformer has a single annular soft magnetic material for magnetic conduction, and the annular soft magnetic material is non-conductive. The winding Q1 on the primary side of the transformer and the winding Q2 on the secondary side of the transformer are wound on both sides of the annular soft magnetic material, respectively.

According to the test results, it was found that when there is a conductor G1 connected to a stable voltage level VEE high-frequency low-resistance electrical connection on the power supply module between the conductor T1 of the primary winding of the transformer and the conductor T2 of the secondary winding of the transformer, due to the stable voltage level of the conductor G1, it is difficult for the conductor T2 to be affected by the level of the conductor T1 that is physically farther away. Therefore, the wide band common mode oscillation is further effectively reduced.

In practice, the wireless charger further comprising a transmission cable having at least one pair of core wires; The secondary side TF2 of the transformer is electrically connected to the first end of the transmission cable core through a second high-frequency low-resistance circuit; The second end of the transmission cable core wire is electrically connected to the corresponding lead of the coil module through a third high-frequency low-resistance circuit.

According to the test, any of the cable core wires is one or a combination of four forms, including a single-strand conductor, a plurality of conductors without an insulating layer at all, a conductor with an insulating layer in a plurality-strand part, and a plurality of strands all having an insulating layer. does not affect the extremely low electromagnetic noise of the wireless charger disclosed in the present invention.

According to the test, when the third high-frequency low-resistance circuit set between the transmission cable core and the coil module is with a third capacitor group Cg3, the highest voltage on the transmission cable core can be significantly reduced while maintaining the same transmission power, which is beneficial for safety.

The beneficial effects of the present invention include the following points.

Realizing extremely low electromagnetic noise in the entire frequency domain: The actual test results of electromagnetic noise show that the wireless charger of the present invention is 20˜30 dB lower than qualified wires, far superior to other low-cost wireless chargers.

The circuit structure is simple, the production process is few, and the production cost is very low.

When working, the coil module will not generate additional heat loss or safety hazards other than its own iron and copper losses.

Due to the isolation function of transformers, they can be used in high-voltage situations to achieve high and low voltage isolation and conversion between the primary and secondary sides of transformers.

### BRIEF DESCRIPTION OF THE DRAWINGS

FIG. 1 shows the circuit topology of other wireless charger embodiments.

FIG. 2 shows the first embodiment of the present invention.

FIG. 3 shows the second embodiment of the present invention.

FIG. 4 shows the third embodiment of the present invention.

FIG. 5 shows the first embodiment of the transformer according to the present invention.

FIG. 6 shows the second embodiment of the transformer according to the present invention.

FIG. 7 shows the fourth embodiment of the present invention.

FIG. 8 shows the fifth embodiment of the present invention.

FIG. 9 shows the sixth embodiment of the present invention.

FIG. 10 is the EMC test chart of the wireless charger with CN201920087512.4 patent technology.

FIG. 11 is the EMC test chart of the present invention.

### DETAILED DESCRIPTION

In order to more clearly illustrate the technical solution of the embodiments of the present invention, a brief introduction will be given to the accompanying drawings required for the description of the embodiments. It is obvious that the accompanying drawings described below are only some embodiments of the present invention and do not limit the scope of application of the present invention.

For ordinary technical personnel in this field, the present invention can be applied to other similar scenarios based on these drawings without creative labor; As shown in this specification and claims, unless the context clearly indicates an exception, words such as “one”, “one”, and/or “such” do not specifically refer to the singular and may also include the plural. Generally speaking, the terms “including” or “containing” only indicate the steps and elements that have been clearly identified, and these steps and elements do not constitute an exclusive list. Methods or devices may also contain other steps or elements. The term ‘based’ means ‘based at least in part’.

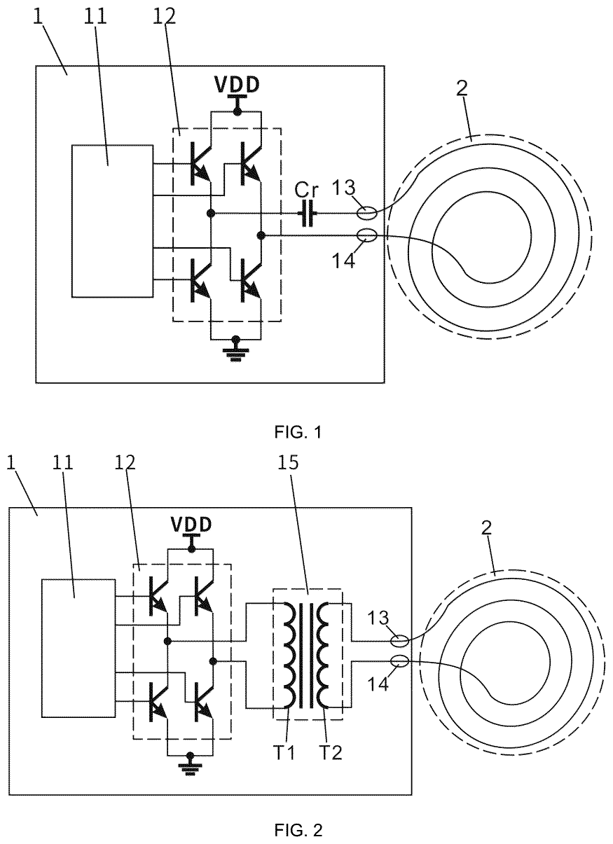

FIG. 1 shows the circuit topology of other wireless chargers. The power supply module 1 includes a control submodule 11, an AC power generation circuit module 12, and a resonant capacitor Cr matched with the coil module 2. The coil module 2 is electrically connected to the AC power output terminals 13/14 of the power supply module 1. VDD is the power supply, and the implementation of the AC power generation submodule 12 includes but is not limited to totem pole circuits and single-sided switch circuits.

FIG. 2 shows the first embodiment of the present invention, in which the power supply module 1 includes a control submodule 11, an AC power generation circuit module 12, a transformer 15, and the coil module 2 is electrically connected to the AC power output terminals 13/14 of the power supply module 1. VDD is the power supply, and the implementation of the AC power generation submodule 12 includes but is not limited to totem pole circuits and single-sided switch circuits.

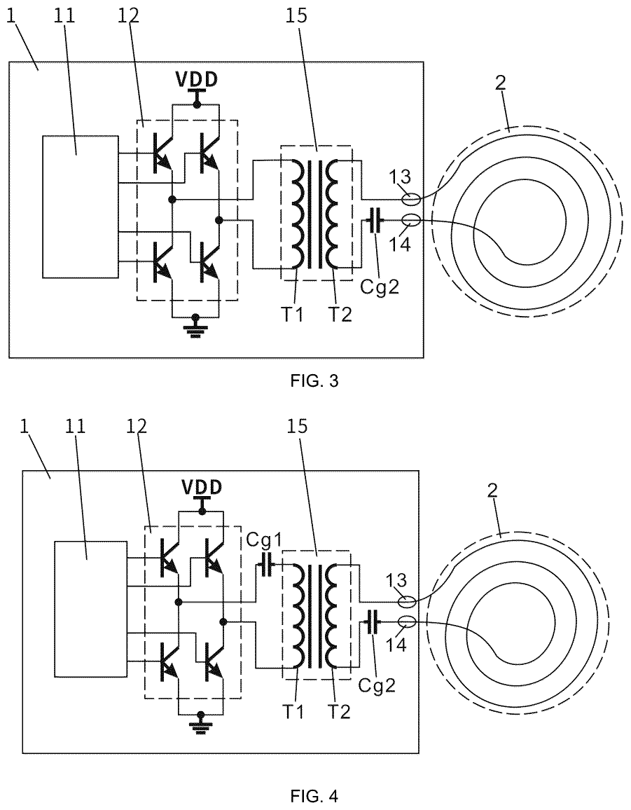

FIG. 3 shows a second embodiment of the present invention, in which the power supply module 1 includes a control submodule 11, an AC power generation circuit module 12, a transformer 15, and a second capacitor group Cg2. The coil module 2 is electrically connected to the AC power output terminals 13/14 of the power supply module 1. VDD is the power supply, and the implementation of the AC power generation submodule 12 includes but is not limited to totem pole circuits and single-sided switch circuits.

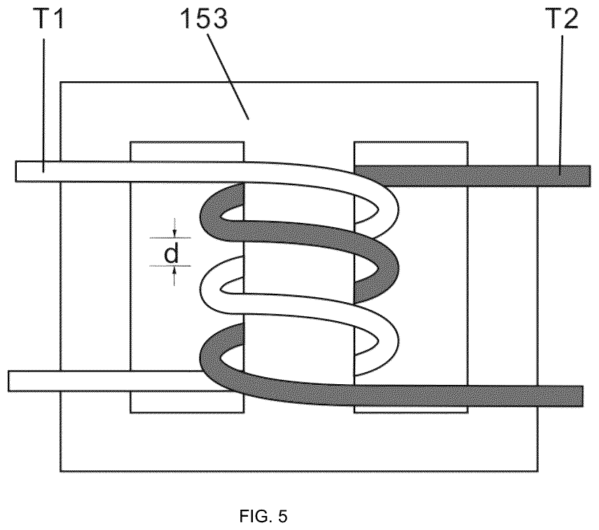

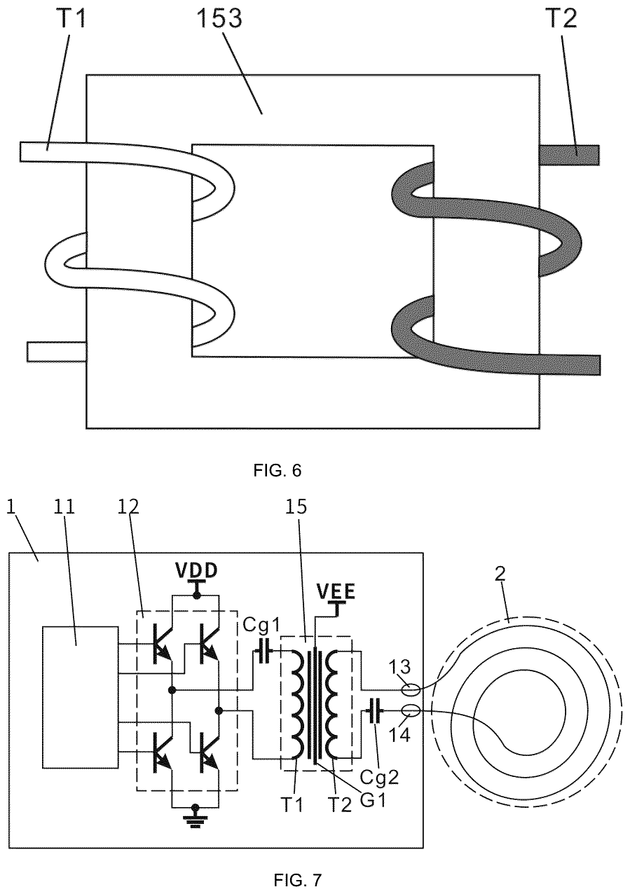

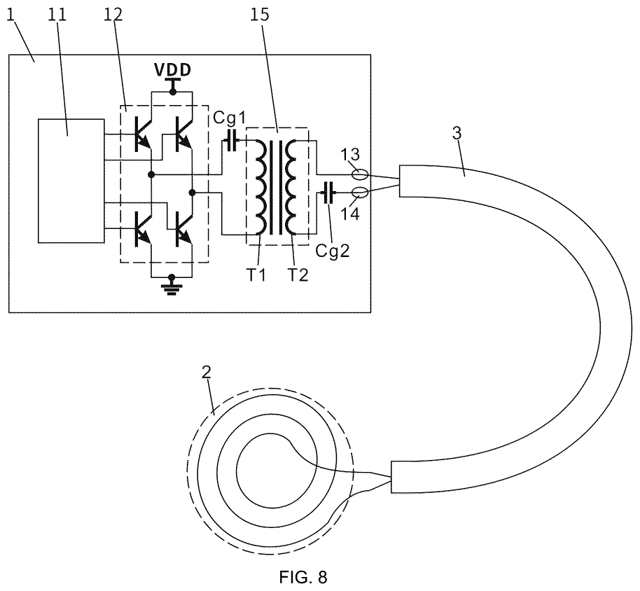

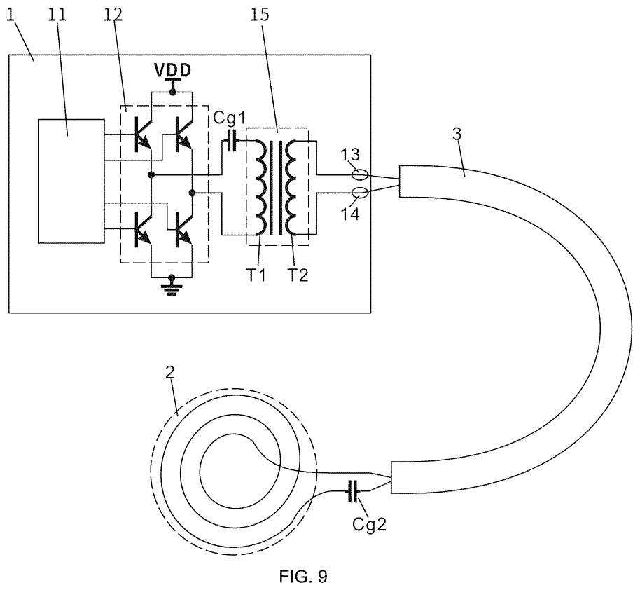

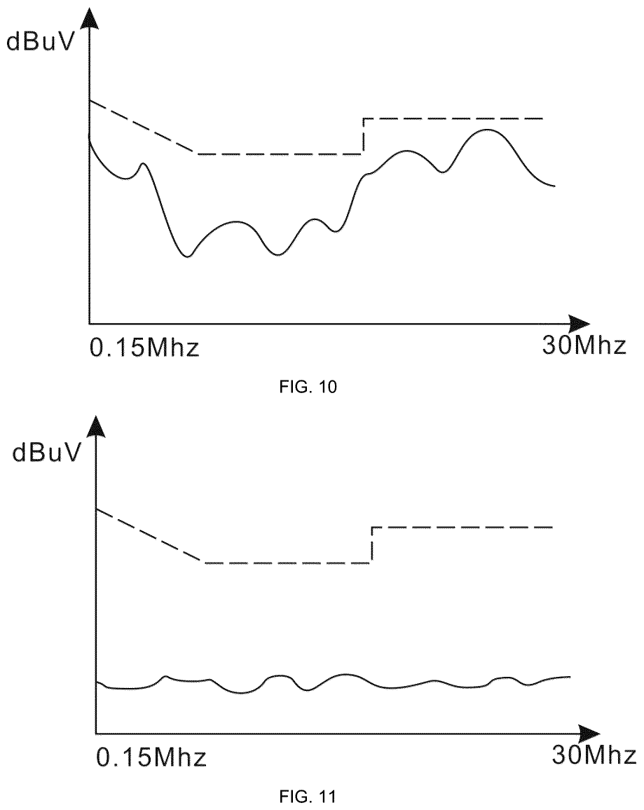

FIG. 4 shows a third embodiment of the present invention, in which the power supply module 1 includes a control submodule 11, an AC power generation circuit module 12, a transformer 15, a first capacitor group Cg1, and a second capacitor group Cg2. The coil module 2 is electrically connected to the AC power output terminals 13/14 of the power supply module 1. VDD is the power supply, and the implementation of the AC power generation submodule 12 includes but is not limited to totem pole circuits and single-sided switch circuits. FIG. 5 shows the first embodiment of the transformer 15 of the present invention, where there is a gap d between the conductor T1 of the transformer primary winding 151 and the conductor T2 of the transformer secondary winding 152, in order to achieve the full frequency domain capacitance value Ct formed between the conductors T1 and T2 during operation.

What is claimed is:

1. A wireless charger characterized by a coil module and a power supply module;
the coil module has a coil converting alternating current energy into an alternating magnetic field, and the coil has at least one pair of alternating energy input leads;
the power supply module has an alternating current generating submodule and a transformer, the alternating current electronic module is electrically connected with the primary side TF1 of the transformer through a first high-frequency low-resistance circuit, and the secondary side TF2 of the transformer is electrically connected with the alternating current energy input leads of the coil module through the second high-frequency low-resistance circuit.

2. The wireless charger of claim 1, is characterized by the second high-frequency low-resistance circuit is with a second capacitor group Cg2, the first end of the second capacitance group Cg2 is electrically connected with the secondary side TF2 of the transformer, and the second end of the second capacitance group Cg2 is electrically connected with the alternating current energy input leads of the coil module.

3. The wireless charger of claim 2, is characterized by the first high-frequency low-resistance circuit is with a first capacitor group Cg1, and the first end of the first capacitor group Cg1 is electrically connected with the output end of the alternating current generating submodule, the second end of the first capacitor group Cg1 is electrically connected with the primary TF1 of the transformer.

4. The wireless charger of claim 1, wherein there is an interval between the conductor T1 of the transformer primary winding and the conductor T2 of the transformer secondary winding, and capacitance formed between the conductor T1 of the transformer primary winding and the conductor T2 of the transformer secondary winding is less than 100 pF.

5. The wireless charger of claim 4, wherein the transformer has a single annular soft magnetic material for magnetic conduction, and the winding Q1 of the primary side of the transformer and the winding Q2 of the secondary side of the transformer are present respectively wound on two sides of the annular soft magnetic material.

6. The wireless charger of claim 4, wherein there is a conductor G1 connected with a certain stable voltage level VEE by high-frequency low-resistance electrically circuit on the power supply module between the conductor T1 of the transformer's primary winding and the conductor T2 of the transformer's secondary winding.

7. The wireless charger of claim 1, wherein it is also characterized by a transmission cable, and the transmission cable has at least one pair of core wires;
The secondary side TF2 of described transformer is electrically connected with the first end of described transmission cable core through a second high-frequency low-resistance circuit;
The second end of the transmission cable core wire is electrically connected with the alternating current energy input leads of the coil module through a third high-frequency low-resistance circuit.

8. A wireless charger as claimed in claim 7, characterized in that any of the cable core wires is one or a combination of four forms: a single-strand conductor, a plurality of conductors without an insulating layer at all, a conductor with an insulating layer in a plurality-strand part, and a plurality of strands all having an insulating layer.

9. A wireless charger as claimed in claim 7, characterized in that third high-frequency low-resistance circuit is with a third capacitor group Cg3, the first end of the second capacitance group Cg3 is electrically connected with the cable core wire, and the second end of the second capacitance group Cg2 is electrically connected with the alternating current energy input leads of the coil module.
